(19) United States
(12) Patent Application Publication
(10) Pub. No.: US 2007/0208504 A1
(43) Pub. Date: Sep. 6, 2007

(54) Method of recognizing intersecting point in navigation system

(75) Inventor: Woo Tak Lee, Ichon-si (KR)

Correspondence Address: STAAS & HALSEY LLP, SUITE 700, 1201 NEW YORK AVENUE, N.W., WASHINGTON, DC, 20005, US

(73) Assignee: HYUNDAI AUTONET CO., LTD., Kyungki-do (KR)

(21) Appl. No.: 11/704,254

(22) Filed: Feb. 9, 2007

(30) Foreign Application Priority Data
Mar. 6, 2006 (KR) 10-2006-0021025

(51) Int. Cl. G01C 21/00

(52) U.S. Cl. 701/208; 701/201

(57) ABSTRACT

A method of recognizing a intersecting point in a navigation system includes a first step of extracting road type information from a road DB if it is determined as a intersecting point in a map DB, a second step of extracting road width information and traffic lane information depending on the extracted road type from the road DB, a third step of extracting GPS error information and map error information from a memory, and a fourth step of calculating the size of the intersecting point based on the extracted GPS error information, map error information, road width information and traffic lane information and recognizing a intersecting point. Therefore, an intersecting point can be recognized as a section, but not a point. Accordingly, there is an advantage in that smooth rotation can be induced at an intersecting point when a vehicle is navigated. Furthermore, when section traffic information is collected employing navigation using GPS, there is an advantage that a transit time between intersecting points can be calculated.

### BACKGROUND OF THE INVENTION

1. Field of the Invention

The present invention relates, in general, to a navigation system, and more particularly to a method of recognizing an intersecting point in a navigation system for a vehicle, wherein the intersecting point is recognized as an intersecting area according to the attribute of the intersecting point in the navigation system, so that the method can be efficiently used in map matching or section traffic information collection.

2. Background of the Related Art

As the type of a wireless mobile communication service is diversified, wireless mobile communications and a position tracking system are combined with a vehicle. In particular, there is an increasing interest in a telematics service in which a vehicle navigation system for servicing real-time traffic information and guiding traffic information service, remote vehicle diagnosis for informing whether a vehicle is abnormal, vehicle position tracking using GPS, and additional information service for providing a variety of information services are integrated.

The telematics system is included in a vehicle. The telematics system serves as a terminal for receiving various pieces of information and provides a variety of computing functions. The telematics system has a position-based information service of receiving the location of a vehicle from a control center and informing a driver of surrounding information, a remote vehicle diagnosis service of connecting a vehicle's electronic control device, a vehicle diagnosis device and a terminal and transmitting the status of a vehicle to the control center in order to check and control the status of the vehicle, and a navigation service of allowing a driver to provide traffic information up to a desired destination.

Of them, the navigation service will be described below in more detail. In this service, an optimal route from a starting place to a destination is decided at a request of a user and the decided route is provided to a user.

To this end, a navigation server (i.e., an information center) decides a route by employing information about a starting place and destination of a navigation vehicle and current traffic information of a staring time point.

However, if the route from the starting place to the destination is decided using traffic information of the staring time point as described above, a dynamic and real-time route guide cannot be provided because traffic information after a lapse of a traveling time is not taken into consideration. Furthermore, there is a disadvantage in that the accuracy of a predicted arrival time is low due to a possibility that traffic situations may be changed during driving.

To overcome the disadvantage, there was proposed a method of periodically planning a route employing updated traffic information, such as accidents and weather, and changing the route.

Meanwhile, in the conventional navigation system, if an intersecting point is recognized by a map matching method, a road is represented as one line in a map using the centerline of the road.

All roads including over-the-road and intersecting points have only one positional value.

However, in the conventional method, it is recognized that all roads including over-the-road and intersecting points have only one positional value. Accordingly, although a vehicle changes its direction or moves across a wide intersecting area when it proceeds, a problem arises because the vehicle is not matched to the intersecting point.

Furthermore, when traffic information on a section basis is obtained using GPS, information, such as a transit time between the intersecting points, cannot be obtained accurately due to the above problem.

### SUMMARY OF THE INVENTION

Accordingly, the present invention has been made in view of the above problems occurring in the prior art, and it is an object of the present invention to provide a method of recognizing an intersecting point in a navigation system for a vehicle, wherein the intersecting point is recognized as an intersecting area according to the attribute of the intersecting point in the navigation system, enabling the method to be efficiently applied to map matching or section traffic information collection.

To achieve the above object, according to an aspect of the present invention, there is provided a method of recognizing an intersecting point in a navigation system, including a first step of extracting road type information from a road DB if it is determined as an intersecting point in a map DB, a second step of extracting road width information and traffic lane information depending on the extracted road type from the road DB, a third step of extracting GPS error information and map error information from a memory, and a fourth step of calculating the size of the intersecting point based on the extracted GPS error information, map error information, road width information and traffic lane information and recognizing the intersecting point.

In the method of recognizing the intersecting point in the navigation system, in the second step, when the road type is an express highway, the road width information is set to 3.5 m, and when the road type is a road other than the express highway, the road width information is set to 3.0 m.

In the method of recognizing the intersecting point in the navigation system, the GPS error information is set to 30 m considering SV clock error, troposphere, an ion layer and a multi-path.

In the method of recognizing the intersecting point in the navigation system, the map error is set to 5 m.

In the method of recognizing the intersecting point in the navigation system, the size of the intersecting point is calculated by adding (GPS error information+map error information+(road width×traffic lane number)) resulting values, which are respectively obtained by multiplying the GPS error information, the map error information, the road width information and the traffic lane number.

### BRIEF DESCRIPTION OF THE DRAWINGS

Further objects and advantages of the invention can be more fully understood from the following detailed description taken in conjunction with the accompanying drawings in which:

FIG. 1 is a block diagram of a navigation system for a vehicle according to an embodiment of the present invention; and

FIG. 2 is a flowchart illustrating a method of recognizing an intersecting point in the navigation system according to an embodiment of the present invention.

### DETAILED DESCRIPTION OF THE PREFERRED EMBODIMENT

A destination setting method of a navigation system according to the present invention will now be described in detail in connection with a specific embodiment with reference to the accompanying drawings.

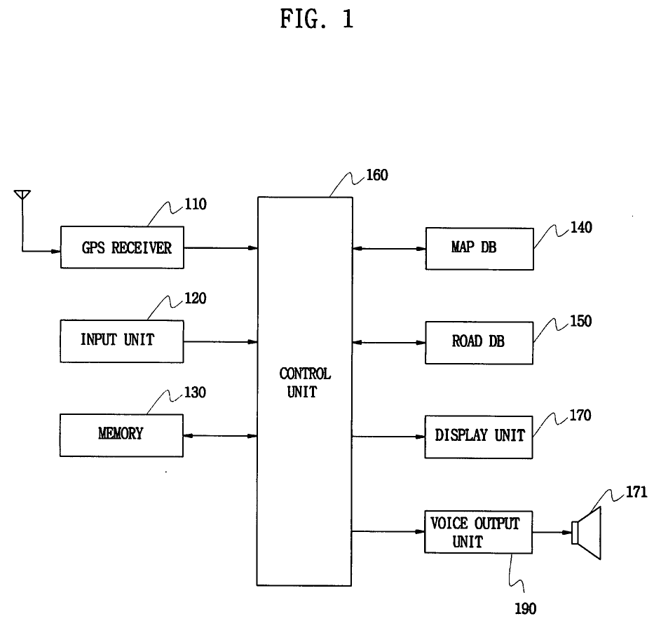

FIG. 1 is a block diagram of a navigation system for a vehicle according to an embodiment of the present invention.

Referring to FIG. 1, the navigation system includes a GPS receiver 110, an input unit 120, a memory 130, a map database (DB) 140, a road DB 150, a control unit 160, a display unit 170, a voice output unit 180 and a speaker 181.

The GPS receiver 110 receives positional information, such as a location and an angle, a traveling velocity of a vehicle, and so on from a GPS satellite. The GPS receiver 110 includes a GPS antenna, etc.

The input unit 120 may be a touch screen, a keypad, etc. for generating a user manipulation signal depending on the manipulation of a user. In general, the input unit 120 includes a keypad device, such as a keyboard, for user manipulation, but may be operated in conjunction with a display device when it includes a touch screen.

The memory 130 stores therein an application program for operating the navigation system, GPS error information, map error information and so on.

The map DB 140 outputs map information of a stored road system.

The road DB 150 stores therein road information (a traffic lane number, a road type, a road width, etc.).

The control unit 160 controls an overall operation of the navigation system. The control unit 160 extracts road width information and traffic lane number information according to a road type if an intersecting point is recognized, calculates the size of the intersecting point based on GPS error information, map error information, the road width information and the traffic lane number, and recognizes the intersecting point. The control unit 160 may be a general central processing unit (CPU) or microprocessor.

The display unit 170 displays thereon a starting place, a destination, an ongoing route, traffic information, parking lot positional information, road information, direction guide information, etc. under the control of the control unit 160.

The voice output unit 180 outputs necessary voice through the speaker 181 at the time of route setting and guide.

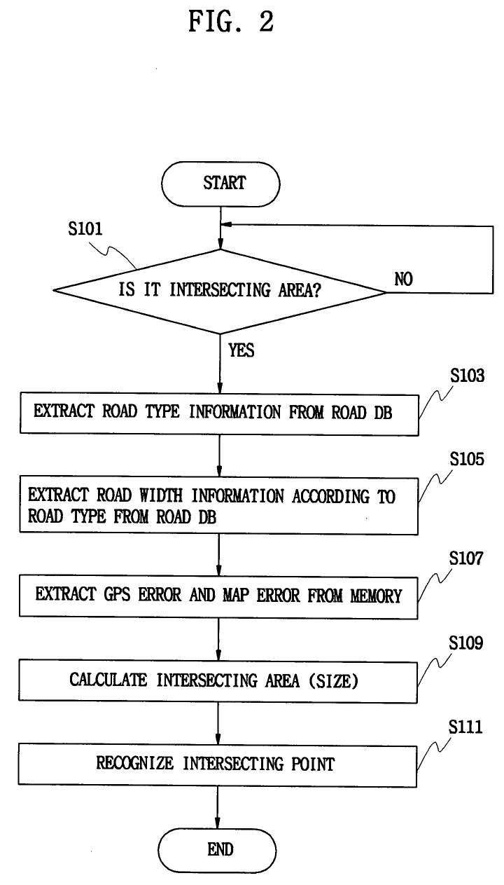

FIG. 2 is a flowchart illustrating a method of recognizing an intersecting point in the navigation system according to an embodiment of the present invention.

Referring to FIG. 2, the method includes a first step S101 and S103 of extracting road type information from the road DB if it is determined as an intersecting point in the map DB; a second step S105 of extracting road width information and traffic lane information depending on the extracted road type from the road DB; a third step S107 of extracting GPS error information and map error information from the memory; and a fourth step S109 and S111 of calculating the size of the intersecting point based on the extracted GPS error information, map error information, road width information and traffic lane information and recognizing the intersecting point.

In the intersecting point recognition method of the navigation system according to the present invention, when the road type is an express highway, the road width information is set to 3.5 m. When the road type is a road other than the express highway, the road width information is set to 3.0 m. The GPS error information is set to 30 m considering SV clock error, troposphere, an ion layer, a multi-path, etc. The map error is set to 5 m. Furthermore, the resulting values obtained by multiplying the GPS error information, the map error information, the road width information and the traffic lane number, respectively, are added to generate the size of the intersecting point.

A navigation service method according to the present invention will be described below with reference to FIGS. 1 and 2.

If it is determined as an intersecting point while matching a map using the map matching method with the navigation system being driven as step S101, the control unit 160 extracts road type information from the road DB 150 at step S103.

The road type information refers to information that decides an express highway, a country road, a main road and so on.

The control unit 160 extracts road width information and traffic lane number information depending on the extracted road type from the road DB 150 at step S105.

The road width information is set to 3.5 m in the case of an express highway and is set to 3.0 m in roads other than the express highway.

The control unit 160 extracts GPS error information and map error information that are previously stored in the memory 130 at step S107.

The GPS error information is error information considering SV clock error, troposphere, an ion layer, a multi-path, etc. The reception accuracy of a GPS signal is 2 dRMS (Dimension Root Mean Square), i.e., error of 25 to 30 m when the error probability is about 95% on the horizon. In the present invention, the reception accuracy is assumed to be 30 m.

Furthermore, it is considered that the map error information has map error of 5 to 10 m though error differs depending on the type of a map, an area and examined situations. In the present invention, the map error information is assumed to be 5 m.

The control unit 160 generates the size of an intersecting area by calculating the extracted information at step S109.

That is, the size of the intersecting area is calculated by a mathematical equation; GPS error information+map error information+(road width*traffic lane number).

For example, when the road type is an express highway and the traffic lane number is a four traffic lane, the size of the intersecting area is 30+5+(3.5*4)=49. When the road type is not the express highway and the traffic lane number is 4, the size of the intersecting area is 30+5+(3.0*4)=47.

If the intersecting point area is fully calculated, the calculated intersecting point area is recognized at step S111.

That is, as noted above, an intersecting point is not recognized as one point as in the prior art, but is recognized as an intersecting area according to the attribute of the intersecting point. Therefore, when traffic information is used, it is determined that a vehicle is located within the intersecting area. Accordingly, smooth rotation can be induced at the intersecting point and a transit time between intersecting points can be calculated.

As described above, in accordance with the method of recognizing the intersecting point in the navigation system according to the present invention, the intersecting point is recognized as a section, but not a point. Accordingly, there is an advantage in that smooth rotation can be induced at an intersecting point when a vehicle is navigated.

Furthermore, when section traffic information is collected employing navigation using GPS, there is an advantage that a transit time between intersecting points can be calculated.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A method of recognizing an intersecting point in a navigation system, the method comprising:
a first step of extracting road type information from a road DB if it is determined as an intersecting point in a map DB;
a second step of extracting road width information and traffic lane information depending on the extracted road type from the road DB;
a third step of extracting GPS error information and map error information from a memory; and
a fourth step of calculating the size of the intersecting point based on the extracted GPS error information, map error information, road width information and traffic lane information and recognizing the intersecting point.

2. The method of claim 1, wherein in the second step, when the road type is an express highway, the road width information is set to 3.5 m, and when the road type is a road other than the express highway, the road width information is set to 3.0 m.

3. The method of claim 1, wherein the GPS error information is set to 30 m considering SV clock error, troposphere, an ion layer, a multi-path, etc.

4. The method of claim 1, wherein the map error information is set to 5 m.

5. The method of claim 1, wherein the size of the intersecting point is calculated by adding (GPS error information+map error information+(road width×traffic lane number)) resulting values, which are respectively obtained by multiplying the GPS error information, the map error information, the road width information and the traffic lane number.
